(19) United States
(12) Patent Application Publication
(10) Pub. No.: US 2015/0147644 A1
(43) Pub. Date: May 28, 2015

(54) NON-AQUEOUS ELECTROLYTE SECONDARY BATTERY

(71) Applicant: Panasonic Intellectual Property Management Co., Ltd., Osaka (JP)

(72) Inventors: MASAHIRO KINOSHITA, Osaka (JP); HIROSHI KAWADA, Osaka (JP)

(21) Appl. No.: 14/530,789

(22) Filed: Nov. 2, 2014

(30) Foreign Application Priority Data
Nov. 28, 2013 (JP) 2013-245608

(51) Int. Cl. H01M 10/0567; H01M 4/525; H01M 10/052; H01M 4/505

(52) U.S. Cl. CPC H01M 10/0567; H01M 4/505; H01M 4/525; H01M 10/052; H01M 2300/0025
USPC 429/200

(57) ABSTRACT

A non-aqueous electrolyte secondary battery of the present disclosure includes: a positive electrode containing a first and a second positive electrode active material; and a non-aqueous electrolyte containing a fluorinated chain carboxylic acid ester represented by the following structural formula 1. The first positive electrode active material includes a lithium-containing transition metal oxide represented by a Li₂MnO₃—LiMO₂ solid solution, and the second positive electrode active material includes a lithium-containing transition metal oxide which contains at least Ni, has a Ni rate of 50 percent by mole or more to the total moles of metal elements other than Li, and has a layered structure.

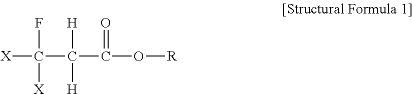

(R represents an alkyl group having 1 to 4 carbon atoms, and X's each independently represent F, H, an alkyl group having 1 to 4 carbon atoms, or a group obtained by substituting at least one H of the above alkyl group by F.)

### BACKGROUND

1. Technical Field

The present disclosure relates to a non-aqueous electrolyte secondary battery.

2. Description of the Related Art

In a lithium-rich transition metal oxide represented by Li₂MnO₃(Li[Li_{1/3}Mn_{2/3}]O₂) or a solid solution thereof, since Li is contained in a transition metal layer other than a Li layer, the amount of Li, which is involved in charge and discharge, is large. Hence, this lithium-rich transition metal oxide has drawn attention as a high capacity positive electrode material (for example, see U.S. Pat. No. 6,677,082). In addition, as an electrolyte solvent for a high voltage application, the use of a fluorinated chain carboxylic acid ester, such as fluorinated methyl propionate, has been proposed (for example, see Japanese Unexamined Patent Application Publication No. 2012-104335).

### SUMMARY

However, a related non-aqueous electrolyte secondary battery had a low energy density and insufficient durability.

A non-aqueous electrolyte secondary battery according to the present disclosure comprises: a positive electrode which contains a first positive electrode material and a second positive electrode material, the first positive electrode material including a lithium-containing transition metal oxide in the form of a Li₂MnO₃—LiMO₂ solid solution (M represents at least one selected from Ni, Co, Fe, Al, Mg, Ti, Sn, Zr, Nb, Mo, W, and Bi), the second positive electrode material including a lithium-containing transition metal oxide which contains at least Ni, which has a Ni rate of 50 percent by mole or more with respect to the total moles of metal elements other than Li, and which has a layered structure; and a non-aqueous electrolyte containing a fluorinated chain carboxylic acid ester represented by the following structural formula 1.

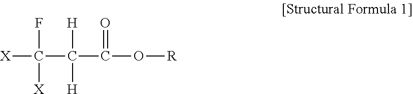

(R represents an alkyl group having 1 to 4 carbon atoms, and X's each independently represent F, H, an alkyl group having 1 to 4 carbon atoms, or a group in which at least one hydrogen atom of the alkyl group is substituted by a fluorine atom.)

According to the present disclosure, a non-aqueous electrolyte secondary battery having a high energy density and excellent durability can be provided.

### BRIEF DESCRIPTION OF THE DRAWINGS

FIG. 1 is a graph showing the amounts of metal elution (storage characteristics in high-temperature charging) of non-aqueous electrolyte secondary batteries which are examples of an embodiment of the present disclosure; and

FIG. 2 is a graph showing cycle characteristics of the non-aqueous electrolyte secondary batteries which are the examples of the embodiment of the present disclosure.

### DETAILED DESCRIPTION

### Findings as Basis of Present Disclosure

Incidentally, when a fluorinated chain carboxylic acid ester, such as a fluorinated methyl propionate, is used as an electrolyte, the fluorinated chain carboxylic acid ester is oxidatively decomposed on the surface of a positive electrode, and as a result, hydrogen fluoride (HF) is generated. Since this HF elutes a metal which forms a positive electrode active material, cycle characteristics and storage characteristics are degraded thereby. When a battery voltage is high, or when a lithium-rich positive electrode active material containing a large amount of Mn is used, this type of problem remarkably occurs.

In order to suppress the metal elution which causes the problem when a fluorinated chain carboxylic acid ester is used and to develop a non-aqueous electrolyte secondary battery which has a high energy density and excellent durability, the present inventors carried out intensive research. Through this intensive research, it was found that when a lithium-rich positive electrode active material (first positive electrode active material) containing a large amount of Mn and a positive electrode active material (second positive electrode active material) which has a Ni rate of 50 percent by mole or more with respect to the total moles of metal elements other than Li are simultaneously present as a positive electrode active material, the amount of metal elution can be significantly reduced. Although the reason why the specific effect as described above can be obtained and the mechanism how HF causes battery degradation have not been clarified yet, the present inventors have conceived as described below.

When a fluorinated chain carboxylic acid ester is oxidatively decomposed on a positive electrode surface, HF is generated. HF reduces a metal, in particular Mn, contained in a positive electrode active material. As a result, the amount of metal elution is increased, and the degradation in battery is promoted. On the other hand, Ni contained in the second positive electrode active material can efficiently trap HF. Accordingly, when the second positive electrode active material in which the rate of Ni with respect to the total moles of transition metals is set to 50 percent by mole or more is mixed with the first positive electrode active material, this reduction reaction can be suppressed. As a result, the amount of metal elution can be significantly reduced. The findings are too unique to be conceived by a person skilled in the art.

Based on the findings described above, the present inventors invented the following aspects of the present disclosure.

A non-aqueous electrolyte secondary battery according to a first aspect of the present disclosure comprises, for example:

a positive electrode containing a first positive electrode active material that contains a lithium-containing transition metal oxide in the form of a Li2MnO3-LiMO2 solid solution (M represents at least one selected from Ni, Co, Fe, Al, Mg, Ti, Sn, Zr, Nb, Mo, W, and Bi), and a second positive electrode active material that contains a lithium-containing transition metal oxide including at least Ni, the lithium-containing transition metal oxide having Ni rate of 50 percent by mole or more with respect to the total moles of metal elements other than Li, and the lithium-containing transition metal oxide having a layered structure; and

a non-aqueous electrolyte containing a fluorinated chain carboxylic acid ester represented by a structural formula 1.

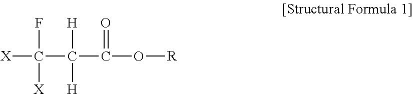

(R represents an alkyl having 1 to 4 carbon atoms, and X's each independently represent F, H, an alkyl having 1 to 4 carbon atoms, or a group in which at least one hydrogen atom of the alkyl group is substituted by a fluorine atom.)

According to the first aspect of the present disclosure, in the second positive electrode active material, the rate of Ni with respect to the total moles of metal elements other than Li is set to 50 percent by mole or more. The second positive electrode active material not only functions as a positive electrode active material but also functions to efficiently trap HF generated by decomposition of a fluorinate solvent, to suppress the metal elution from the positive electrode, and to improve the cycle characteristics. Accordingly, a non-aqueous electrolyte secondary battery having a high energy density and excellent durability can be provided.

According to a second aspect of the present disclosure, for example, the first positive electrode active material of the non-aqueous electrolyte secondary battery according to the first aspect may include the lithium-containing transition metal oxide represented by a general formula: Li₁₊ₐ(Mn_{b}M_{1-b})₁₋ₐO_{2+c} {0.1≦a≦0.33, 0.5≦b≦1.0, −0.1≦c≦0.1}. The second positive electrode active material of the non-aqueous electrolyte secondary battery according to the first aspect of the present disclosure may include the lithium-containing transition metal oxide represented by a general formula: Li₁₊ₚ(Ni_{q}M*_{1-q})₁₋ₚO₂₊ᵣ {0≦p<0.1, 0.5≦q≦1.0, −0.1≦r≦0.1, and M* represents at least one selected from Co, Mn, Fe, Al, Mg, Ti, Sn, Zr, Nb, Mo, W, and Bi}.

According to a third aspect of the present disclosure, for example, a content of the first positive electrode active material of the non-aqueous electrolyte secondary battery according to the first or the second aspect may be 40 to 90 percent by weight with respect to the total weight of the first and second positive electrode active material. A content of the second positive electrode active material of the non-aqueous electrolyte secondary battery according to the first or the second aspect may be 10 to 60 percent by weight with respect to the total weight of the first and second positive electrode active materials.

According to the third aspect of the present disclosure, an increase in capacity and an excellent durability can be simultaneously achieved.

According to a fourth aspect of the present disclosure, for example, a content of the fluorinated chain carboxylic acid ester of the non-aqueous electrolyte secondary battery according to any one of the first to the third aspects may be 30 percent by volume or more with respect to the total volume of a non-aqueous solvent of the non-aqueous electrolyte.

The fluorinated chain carboxylic acid ester has a low viscosity as compared to that of other fluorinated solvents, such as a fluorinated cyclic ester, and is not likely to be decomposed as compared to a non-fluorinated solvent. According to the fourth aspect of the present disclosure, since the content of the fluorinated chain carboxylic acid ester is 30 percent by volume or more with respect to the total volume of the non-aqueous solvent of the non-aqueous electrolyte, a high battery voltage can be achieved.

According to a fifth aspect of the present disclosure, for example, the fluorinated chain carboxylic acid ester of the non-aqueous electrolyte secondary battery according to any one of the first to the fourth aspects may include a fluorinated methyl propionate.

According to a sixth aspect of the present disclosure, for example, the non-aqueous electrolyte secondary battery according to any one of the first to the fifth aspects may have a charge cutoff voltage of 4.4 to 5.0 V.

Hereinafter, embodiments of the present disclosure will be described in detail.

A non-aqueous electrolyte secondary battery which is one example of one embodiment of the present disclosure includes a positive electrode, a negative electrode, and a non-aqueous electrolyte containing a non-aqueous solvent. In addition, between the positive electrode and the negative electrode, at least one separator is preferably provided. The non-aqueous electrolyte secondary battery has, for example, a structure in which an electrode body formed by winding the positive electrode and the negative electrode with the separator provided therebetween and the non-aqueous electrolyte are received in an outer package body.

Although not particularly limited, the charge cutoff voltage is preferably 4.4 V or more, more preferably 4.5 V or more, and particularly preferably 4.55 to 5.0 V. In particular, the non-aqueous electrolyte secondary battery of the present disclosure is preferably used for a high voltage application at a charge cutoff voltage of 4.4 V or more.

### [Positive Electrode]

The positive electrode includes, for example, a positive electrode current collector, such as metal foil, and a positive electrode active material layer formed on the positive electrode current collector. As the positive electrode current collector, for example, there may be used foil formed from a metal, such as aluminum, which is stable in a potential range of the positive electrode or a film on which a metal, such as aluminum, which is stable in the potential range of the positive electrode is provided. The positive electrode active material layer preferably contains a conductive agent and a binder besides the positive electrode active material.

As the positive electrode active material, at least two types of active materials (a first positive electrode active material and a second positive electrode active material) are contained. The first positive electrode active material is a lithium-containing transition metal oxide in the form of a Li₂MnO₃—LiMO₂ solid solution (M represents at least one selected from Ni, Co, Fe, Al, Mg, Ti, Sn, Zr, Nb, Mo, W, and Bi). The second positive electrode active material is a lithium-containing transition metal oxide which contains at least Ni, which has a Ni rate of 50 percent by mole or more with respect to the total moles of metal elements other than Li, and which has a layered structure.

The first positive electrode active material is a lithium-rich lithium-containing transition metal oxide in which Li is also contained in at least one transition metal layer other than the Li layer. In a powder X-ray diffraction pattern of this oxide, a peak derived from the superlattice structure is observed in the vicinity of 20=20° to 25°. In particular, in a discharged state or an unreacted state, the first positive electrode active material is preferably a lithium-containing transition metal oxide represented by a general formula: Li₁₊ₐ(Mn_{b}M_{1-b})₁₋ₐO_{2+c} {0.1≦a≦0.33, 0.5≦b≦1.0, −0.1≦c≦0.1}.

A preferable first positive electrode active material is a Li₂MnO₃—LiMO₂ solid solution which contains Ni and Co as M, and for example, Li_{1.2}Ni_{0.13}Co_{0.13}Mn_{0.13}O₂ or Li_{1.13}Ni_{0.63}Co_{0.12}Mn_{0.12}O₂ may be mentioned. In the first positive electrode active material, when 0.1≦a≦0.33 is satisfied, it is believed that the structural stability is improved, and stable charge/discharge characteristics can be realized. In addition, when 0.5≦b≦1.0 is satisfied, the increase in capacity can be realized.

The second positive electrode active material not only functions as a positive electrode active material but also functions to efficiently trap HF generated in decomposition of a fluorinated solvent, suppress the metal elution from the positive electrode, and improve the cycle characteristics. More precisely, only when the first positive electrode active material and the second positive electrode active material are simultaneously present, the metal elution is specifically suppressed, and the cycle characteristics can be improved. Although the reason why this specific effect is obtained and the mechanism how HF causes battery degradation have not been clarified yet, the present inventors believe that since Mn contained in the first positive electrode active material is particularly liable to be reduced by HF, the amount of metal elution is increased, and as a result, the battery degradation is promoted. In addition, through intensive research carried out based on the assumption that the above reduction reaction can be suppressed when the first positive electrode active material is mixed with the second positive electrode active material which has a Ni rate of 50 percent by mole or more with respect to the total moles of the transition metal elements, the above advantageous effect could be found.

The second positive electrode active material is a lithium-containing transition metal oxide having a layered structure in which the rate of Ni with respect to the total moles of metal elements other than Li is 50 percent by mole or more. In particular, in a discharged state or an unreacted state, the second positive electrode active material is preferably a lithium-containing transition metal oxide represented by a general formula: Li₁₊ₚ(Ni_{q}M*_{1-q})₁₋ₚO₂₊ᵣ {0≦p<0.1, 0.5≦q≦1.0, −0.1≦r≦0.1, and M* represents at least one selected from Co, Mn, Fe, Al, Mg, Ti, Sn, Zr, Nb, Mo, W, and Bi}.

A preferable second positive electrode active material is a Li-containing transition metal oxide which contains Co and Mn as the transition metal besides Ni, and for example, LiNi_{0.5}Co_{0.2}Mn_{0.3}O₂, LiNi_{0.6}Co_{0.2}Mn_{0.2}O₂, LiNi_{0.5}Mn_{0.5}O₂, or LiNi_{0.8}Co_{0.15}Al_{0.05}O₂ may be mentioned. In the second positive electrode active material, when 0.5≦q≦1.0 is satisfied, the battery degradation caused by HF as described above can be suppressed, and it is also preferable in view of the increase in capacity. In addition, the second positive electrode active material may be synthesized by a method similar to that for the first positive electrode active material.

The content of the first positive electrode active material is, with respect to the total weight of the positive electrode active material, preferably 40 to 90 percent by weight and more preferably 50 to 80 percent by weight. The content of the second positive electrode active material is, with respect to the total weight of the positive electrode active material, preferably 10 to 60 percent by weight and more preferably 20 to 50 percent by weight. When the contents of those two positive electrode active materials are set in the above respective ranges, the increase in capacity and an excellent durability can be simultaneously achieved. The positive electrode active material is a material obtained, for example, by mixing the first positive electrode active material and the second positive electrode active material at a weight ratio of 1:1.

The positive electrode active material may includes other metal oxides and the like in the form of a mixture or a solid solution as long as the object of the present disclosure is not impaired. In addition, the surface of the positive electrode active material may be covered with fine particles of a metal oxide, such as aluminum oxide (Al₂O₃), a metal fluoride, such as aluminum fluoride (AlF₃), or an inorganic compound, such as a phosphoric acid compound or a boric acid compound.

The conductive agent described above is used to enhance the electrical conductivity of the positive electrode active material layer. As the conductive agent, a carbon material, such as carbon black, acetylene black, ketjen black, or graphite, may be mentioned by way of example. Those carbon materials may be used alone, or at least two types thereof may be used in combination.

The binder described above is used to maintain a preferable contact state between the positive electrode active material and the conductive agent and to enhance the binding property of the positive electrode active material and the like to the surface of the positive electrode current collector. As the binder, for example, a polytetrafluoroethylene (PTFE), a poly(vinylidene fluoride) (PVdF), or a modified substance thereof may be mentioned. The binder may be used together with a thickening agent, such as a carboxymethyl cellulose (CMC) or a poly(ethylene oxide) (PEO). Those binders may be used alone, or at least two types thereof may be used in combination.

### [Negative Electrode]

The negative electrode includes, for example, a negative electrode current collector, such as metal foil, and a negative electrode active material layer formed on the negative electrode current collector. As the negative electrode current collector, for example, there may be used foil formed from a metal, such as copper, which is stable in a potential range of the negative electrode or a film on which a metal, such as copper, which is stable in the potential range of the negative electrode is provided. The negative electrode active material layer preferably contains a binder besides the negative electrode active material which is capable of occluding and releasing lithium ions. As the binder, although a PTFE or the like may also be used as in the case of the positive electrode, a styrene-butadiene copolymer (SBR) or a modified substance thereof is preferably used. The binder may be used together with a thickening agent, such as a CMC.

As the negative electrode active material, for example, there may be used natural graphite, artificial graphite, lithium, silicon, carbon, tin, germanium, aluminum, lead, indium, gallium, a lithium alloy, carbon and silicon in each of which lithium is occluded in advance, and an alloy and a mixture of those mentioned above.

### [Non-Aqueous Electrolyte]

The non-aqueous electrolyte contains a non-aqueous solvent and an electrolytic salt dissolved therein. The non-aqueous solvent includes at least a fluorinated chain carboxylic acid ester represented by the structural formula 1. In addition, the non-aqueous electrolyte is not limited to a liquid electrolyte (non-aqueous electrolytic solution) and may be a solid electrolyte using a gel polymer or the like.

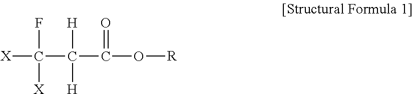

In the above formula, R represents an alkyl group having 1 to 4 carbon atoms, and X's each independently represent F, H, an alkyl group having 1 to 4 carbon atoms, or a group obtained by substituting at least one hydrogen atom of the above alkyl group by a fluorine atom.

Since having a low viscosity as compared to that of other fluorinated solvents, such as a fluorinated cyclic ester, and being unlikely to be decomposed as compared to a non-fluorinated solvent, the above fluorinated chain carboxylic acid ester is a preferable solvent, particularly when the battery voltage is high. However, since a carbon atom adjacent to the carboxyl group has a positive charge, hydrogen bonded to this carbon atom is liable to be released in the form of a proton. Hence, although the fluorinated chain carboxylic acid ester is liable to generate HF as compared to other fluorinated solvents, since the second positive electrode active material functions as a HF trapping agent as described above, the metal elusion is suppressed.

As a particular example of the fluorinated chain carboxylic acid ester, for example, there may be mentioned an ester obtained by substituting by a fluorine atom, at least one hydrogen of methyl propionate, ethyl propionate, propyl propionate, isobutyl propionate, butyl propionate, isobutyl propionate, methyl butyrate, ethyl butyrate, propyl butyrate, isopropyl butyrate, butyl butyrate, isobutyl butyrate, methyl valerate, ethyl valerate, propyl valerate, isopropyl valerate, butyl valerate, isobutyl valerate, or the like. Among those mentioned above, a fluorinated methyl propionate (FMP) and a fluorinated ethyl propionate are preferable, and in particular, methyl 3,3,3-trifluoropropionate is preferable. The fluorinated chain carboxylic acid ester may be used alone, or at least two types thereof may be used in combination.

As the non-aqueous solvent, although the above fluorinated chain carboxylic acid ester may only be used, another fluorinated solvent, such as a fluorinated cyclic carbonic acid ester or a fluorinated chain carbonic acid ester, may be preferably used together therewith, and in particular, a fluorinated cyclic carbonic acid ester is preferably used together with the fluorinated chain carboxylic acid ester. However, the content of the fluorinated chain carboxylic acid ester is preferably higher than that of the other fluorinated solvent and more preferably highest among all the solvent components. In particular, the content is, with respect to the total volume of the non-aqueous solvent, preferably 30 percent by volume or more, more preferably 35 to 90 percent by volume, and particularly preferably 40 to 85 percent by volume.

As the fluorinated cyclic carbonic acid ester, a fluoroethylene carbonate or a derivative thereof is preferably used. As the fluoroethylene carbonate, for example, there may be mentioned 4-fluoroethylene carbonate, 4,5-difluoroehtylene carbonate, 4,4-difluoroehtylene carbonate, or 4,4,5-trifluoroehtylene carbonate.

As the fluorinated chain carbonic acid ester, there may be mentioned a lower chain carbonic acid ester, such as a carbonic acid ester obtained by substituting by a fluorine atom, at least one hydrogen of dimethyl carbonate, ethyl methyl carbonate, diethyl carbonate, methyl propyl carbonate, ethyl propyl carbonate, methyl isopropyl carbonate, or the like.

The non-aqueous solvent may be used together with a non-fluorinated solvent in view of reduction in cost and the like. However, the content of the solvent other than the fluorinated solvent is, with respect to the total volume of the non-aqueous solvent, set to preferably less than 50 percent by volume or less, more preferably less than 40 percent by volume, and particularly preferably less than 30 percent by volume. As the non-fluorinated solvent, for example, a cyclic carbonate, a chain carbonate, a carboxylic acid ester, a cyclic ether, a chain ether, a nitrile, an amide, or a mixture thereof may be mentioned.

As an example of the cyclic carbonate, for example, ethylene carbonate, propylene carbonate, or butylene carbonate may be mentioned.

As an example of the chain carbonate, for example, dimethyl carbonate, methyl ethyl carbonate, diethyl carbonate, methyl propyl carbonate, ethyl propyl carbonate, or methyl isopropyl carbonate may be mentioned.

As an example of the carboxylic acid ester, for example, methyl acetate, ethyl acetate, propyl acetate, methyl propionate, ethyl propionate, or γ-butyrolactone may be mentioned.

As an example of the cyclic ether, for example, 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol, or a crown ether may be mentioned.

As an example of the chain ether, for example, 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1.1-dimethoxymethane, 1,1-diethoxyethane, triethylene glycol dimethyl ether, or tetraethylene glycol dimethyl ether may be mentioned.

As an example of the nitrile, for example, acetonitrile may be mentioned, and as an example of the amide, for example, dimethylformamide may be mentioned.

The electrolytic salt described above is preferably a lithium salt. As the lithium salt, a salt which has been generally used as a supporting salt in a related non-aqueous electrolyte secondary battery may be used. As a particular example, LiPF₆, LiBF₄, LiAsF₆, LiClO₄, LiCF₃SO₃, LiN(FSO₂)₂, LiN(CₗF₂ₗ₊₁SO₂)(CₘF₂ₘ₊₁SO₂) (l and m each indicate an integer of 1 or more), LiC(CₚF₂ₚ₊₁SO₂)(C_{q}F_{2q+1}SO₂)(CᵣF₂ᵣ₊₁SO₂) (p, q, and r each indicate an integer of 1 or more), Li[B(C₂O₄)₂] (bis(oxalate)lithium borate (LiBOB)), Li[B(C₂O₄)F₂], Li[P(C₂O₄)F₄], or Li[P(C₂O₄)F₂] may be mentioned by way of example. Those lithium salts may be used alone, or at least two types thereof may be used in combination.

### [Separator]

As the separator, a porous sheet having ion permeability and insulating properties may be used. As a particular example of the porous sheet, for example, a fine porous thin film, a woven cloth, or an unwoven cloth may be mentioned. As a material for the separator, a cellulose or an olefinic resin, such as a polyethylene or a polypropylene, is preferably used. The separator may be a laminate including a cellulose fiber layer and a layer formed of a thermoplastic resin, such as an olefinic resin.

### EXAMPLES

Hereinafter, although the present disclosure will be further described with reference to examples, the present disclosure is not limited to those examples.

### Example 1

### Formation of Positive Electrode

After a mixture containing 92 percent by mass of a positive electrode active material, 5 percent by mass of acetylene black, and 3 percent by mass of a poly(vinylidene fluoride) was formed, this mixture was kneaded with N-methyl-2-pyrollidone to form a slurry. Subsequently, on an aluminum foil current collector functioning as a positive electrode current collector, the slurry thus prepared was applied, followed by performing drying and rolling, so that a positive electrode was formed.

As the positive electrode active material, a mixture was used which was obtained by mixing Li_{2.2}Mn_{0.54}Ni_{0.13}Co_{0.13}O₂ (hereinafter referred to as “first positive electrode active material”) and LiNi_{0.5}Co_{0.2}Mn_{0.3}O₂ (hereinafter referred to as “second positive electrode active material”) at a weight ratio of 1:1.

### (Synthesis of First Positive Electrode Active Material)

Manganese sulfate (MnSO₄), nickel sulfate (NiSO₄), and cobalt sulfate (CoSO₄) were mixed together in an aqueous solution and were co-precipitated, so that a precursor represented by (Mn,Ni,Co)(OH)₂ was obtained. Subsequently, after this precursor was mixed with lithium hydroxide monohydrate (LiOH.H₂O), the mixture thus obtained was fired at 850° C. for 12 hours, so that the first positive electrode active material was obtained.

### (Synthesis of Second Positive Electrode Active Material)

After lithium nitrate (LiNO₃), nickel oxide (IV) (NiO₂), cobalt oxide (II,III) (Co₃O₄), and manganese oxide (III) (Mn₂O₃) were mixed together, this mixture thus obtained was fired at 700° C. for 10 hours, so that the second positive electrode active material was obtained.

### [Formation of Negative Electrode]

After a mixture containing 98 percent by mass of graphite, 1 percent by mass of a sodium carboxymethyl cellulose, and 1 percent by mass of a styrene-butadiene copolymer was formed, this mixture was kneaded with water to form a slurry. Subsequently, on a copper foil current collector functioning as a negative electrode current collector, the slurry thus prepared was applied, followed by performing drying and rolling, so that a negative electrode was formed.

### [Formation of Non-Aqueous Electrolyte]

A solvent containing 4-fluoroethylene carbonate and methyl 3,3,3-trifluoropropionate at a volume ratio of 1:3 was prepared, and LiPF₆ was added to the solvent thus prepared to have a concentration of 1.0 mol/l, so that a non-aqueous electrolyte was formed.

### [Formation of Battery]

To the positive electrode (30×40 mm) and the negative electrode (32×42 mm) thus formed, respective lead terminals were fitted. Next, an electrode body was formed so that the positive electrode and the negative electrode faced each other with at least one separator provided therebetween, and this electrode body was sealed in an outer package body together with the non-aqueous electrolyte. Accordingly, a battery A1 having a designed capacity of 50 mAh was formed. The battery A1 thus formed was charged at a constant current of 0.5 It (25 mA) until the voltage reached 4.6 V. Next, after the battery A1 was charged at a constant voltage of 4.6 V until the current reached 0.05 It (2.5 mA), the battery A1 was left stand still for 20 minutes. Subsequently, discharge was performed at a constant current of 0.5 It (25 mA) until the voltage reached 2.5 V. This charge and discharge test was performed 5 cycles, so that the battery A1 was stabilized.

### Comparative Example 1

Except that the above first positive electrode active material was only used as the positive electrode active material, a battery X1 was formed in a manner similar to that in Example 1.

### Comparative Example 2

Except that the above second positive electrode active material was only used as the positive electrode active material, a battery X2 was formed in a manner similar to that in Example 1.

[Evaluation of Amount of Metal Elution after Charging and Storage]

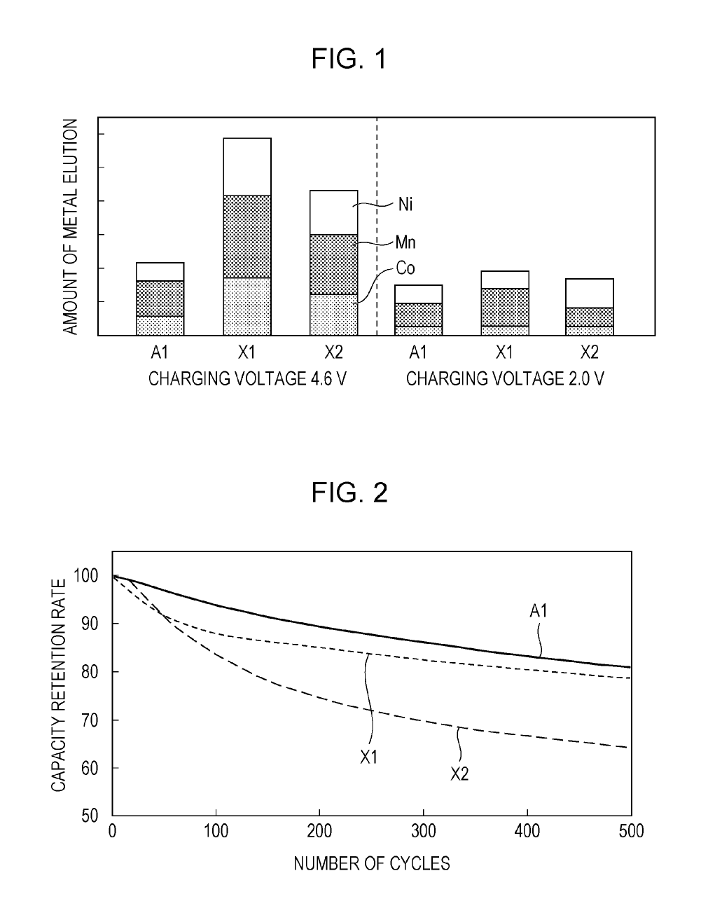

The batteries of the example and comparative examples were each charged at a constant current of 0.5 It (25 mA) until the voltage reached 4.6 V and were each further charged at a constant voltage of 4.6 V until the current reached 0.05 It (2.5 mA). Subsequently, in a constant-temperature bath at 85° C., the batteries were stored for 10 days. Next, after the batteries were disassembled, the negative electrodes (32×42 mm) were recovered. The negative electrode thus recovered was heated after an acid was added thereto, and acid insoluble components were then removed by filtration. Subsequently, a quantitative analysis of transition metals (Co, Ni, Mn) contained in the solution was performed using ICP. The sum of the amounts of Co, Ni, and Mn thus obtained was divided by the weight of the positive electrode active material, and this value thus obtained was regarded as the amount of metal elution from the positive electrode active material. In addition, the amount of metal elution obtained when the charging voltage was set to 2.0 V was also evaluated in a manner similar to that described above. The evaluation results are shown in FIG. 1.

### [Evaluation of Cycle Characteristics]

After the batteries of the example and comparative examples were each charged at a constant current of 0.5 It (25 mA) until the voltage reached 4.6 V and were each further charged at a constant voltage of 4.6 V until the current reached 0.05 It (2.5 mA), the batteries were left stand still for 20 minutes. Subsequently, the batteries were each discharged at a constant current of 0.5 It (25 mA) until the battery voltage reached 2.0 V, so that the charge/discharge capacity (mAh) of the battery was measured. Next, the charge/discharge described above was repeatedly performed, and the discharge capacity after each cycle was divided by the discharge capacity at the first cycle and was then further multiplied by 100, so that the capacity retention rate was obtained for evaluation. The evaluation results are shown in FIG. 2.

As shown in FIG. 1, the amount of metal elution of the battery A1 of the example obtained after the high-temperature charging and storage was significantly small as compared to that of each of the batteries X1 and X2 of the comparative examples. In particular, when the charging voltage was high, the difference in the amount of metal elution amount was significant. In addition, as shown in FIG. 2, compared to the batteries X1 and X2 of the comparative examples, the battery A1 of the example had preferable cycle characteristics.

That is, in the secondary battery using a fluorinated chain carboxylic acid ester as a non-aqueous solvent, when the first positive electrode active material or the second positive electrode active material is only used, the amount of metal elution is large, and preferable cycle characteristics cannot be obtained. However, by the synergistic effect between the first positive electrode active material and the second positive electrode active material, the amount of metal elution can be significantly reduced, and the cycle characteristics are improved.

What is claimed is:

1. A non-aqueous electrolyte secondary battery comprising:
a positive electrode containing:
a first positive electrode material that contains a lithium-containing transition metal oxide in the form of a Li₂MnO₃—LiMO₂ solid solution (M represents at least one selected from Ni, Co, Fe, Al, Mg, Ti, Sn, Zr, Nb, Mo, W, and Bi), and
a second positive electrode material that contains a lithium-containing transition metal oxide including at least Ni, the lithium-containing transition metal oxide having a Ni rate of 50 percent by mole or more with respect to the total moles of metal elements other than Li, and the lithium-containing transition metal oxide having a layered structure; and
a non-aqueous electrolyte containing a fluorinated chain carboxylic acid ester represented by the following structural formula 1: 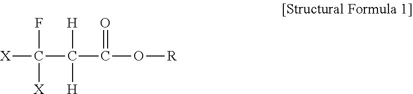
(R represents an alkyl group having 1 to 4 carbon atoms, and X's each independently represent F, H, an alkyl group having 1 to 4 carbon atoms, or a group in which at least one hydrogen atom of the alkyl group is substituted by a fluorine atom).

2. The non-aqueous electrolyte secondary battery according to claim 1,
wherein the first positive electrode active material includes the lithium-containing transition metal oxide represented by a general formula: Li₁₊ₐ(Mn_{b}M_{1-b})₁₋ₐO_{2+c} {0.1≦a≦0.33, 0.5≦b≦1.0, −0.1≦c≦0.1} and,
the second positive electrode active material includes the lithium-containing transition metal oxide represented by a general formula: Li₁₊ₚ(Ni_{q}M*_{1-q})₁₋ₚO₂₊ᵣ {0≦p<0.1, 0.5≦q≦1.0, −0.1≦r≦0.1, and M* represents at least one selected from Co, Mn, Fe, Al, Mg, Ti, Sn, Zr, Nb, Mo, W, and Bi}.

3. The non-aqueous electrolyte secondary battery according to claim 1,
wherein a content of the first positive electrode active material is 40 to 90 percent by weight with respect to the total weight of the first and second positive electrode active materials, and
a content of the second positive electrode active material is 10 to 60 percent by weight with respect to the total weight of the first and second positive electrode active materials.

4. The non-aqueous electrolyte secondary battery according to claim 1,
wherein a content of the fluorinated chain carboxylic acid ester is 30 percent by volume or more with respect to the total volume of a non-aqueous solvent of the non-aqueous electrolyte.

5. The non-aqueous electrolyte secondary battery according to claim 1,
wherein the fluorinated chain carboxylic acid ester includes a methyl fluorinated propionate.

6. The non-aqueous electrolyte secondary battery according to claim 1,
wherein the non-aqueous electrolyte secondary battery has a charge cutoff voltage of 4.4 to 5.0 V.
